(19) United States
(12) Patent Application Publication
(10) Pub. No.: US 2024/0194003 A1
(43) Pub. Date: Jun. 13, 2024

(54) OPERATOR PROFILE BASED SYSTEM

(71) Applicants: AT&T Intellectual Property I, L.P., Atlanta, GA (US); Interwise Ltd., Airport City (IL)

(72) Inventors: Jason Reed, Brooklyn, NY (US); Sujan Lamichhane, Haslet, TX (US); Jinling Wang, Chicago, IL (US); Zahi Itzhak Shneider, Moshav Lachish (IL); Kashif Eijaz, Matawan, NJ (US); Deepthi Jalagam, Naperville, IL (US)

(21) Appl. No.: 18/064,245

(22) Filed: Dec. 9, 2022

(51) Int. Cl. G07C 5/02; B60W 30/18; B60W 50/08; G07C 5/00

(52) U.S. Cl. CPC G07C 5/02; B60W 30/18163; B60W 50/08; G07C 5/008; B60W 2520/10; B60W 2520/105; B60W 2530/10; B60W 2540/043; B60W 2540/049; B60W 2555/20; B60W 2555/60

(57) ABSTRACT

Methods, computer-readable media, and apparatuses for using an aggregated vehicle operation score to implement a remedial action are disclosed. In one example, a processing system including at least one processor may identify a first type of a vehicle to be operated by a driver, monitor operational metrics of the vehicle while the vehicle is being operated by the driver during a journey, generate a first vehicle operation score for the journey, generate an aggregated vehicle operation score based at least on: the first vehicle operation score and a second vehicle operation score for a second type of a vehicle previously operated by the driver, wherein the first type is distinct from the second type, and execute at least one remedial action based on the aggregated vehicle operation score.

The present disclosure relates to network-based transportation management, and more particularly to devices, computer-readable media, and methods for using an operator profile (e.g., broadly a vehicle usage profile) to implement a remedial action in response to an aggregated vehicle operation score, e.g., generated across a plurality of different vehicle types (e.g., a plurality of mobile platform types).

### BACKGROUND

The behavior of an individual can be ascertained in many different contexts that can be utilized to assist the individual in performing an action or to provide insights to third party service providers who are providing a service to the individual. For example, operation of a vehicle (broadly a mobile platform of any type) may be a daily occurrence for many individuals. The operational metrics of the vehicle are currently not effectively collected and/or utilized to provide benefits to the individuals.

### SUMMARY

The present disclosure broadly discloses methods, computer-readable media, and systems for using an aggregated vehicle operation score to implement a remedial action. In one example, a method performed by a processing system including at least one processor includes identifying a first type of a vehicle to be operated by a driver, monitoring operational metrics of the vehicle while the vehicle is being operated by the driver during a journey, generating a first vehicle operation score for the journey, generating an aggregated vehicle operation score based at least on: the first vehicle operation score and a second vehicle operation score for a second type of a vehicle previously operated by the driver, wherein the first type is distinct from the second type, and executing at least one remedial action based on the aggregated vehicle operation score.

In another example, a non-transitory computer-readable medium may store instructions which, when executed by a processing system including at least one processor, cause the processing system to perform operations. The operations may include identifying a first type of a vehicle to be operated by a driver, monitoring operational metrics of the vehicle while the vehicle is being operated by the driver during a journey, generating a first vehicle operation score for the journey, generating an aggregated vehicle operation score based at least on: the first vehicle operation score and a second vehicle operation score for a second type of a vehicle previously operated by the driver, wherein the first type is distinct from the second type, and executing at least one remedial action based on the aggregated vehicle operation score.

In another example, a device may include a processing system including at least one processor and a non-transitory computer-readable medium storing instructions which, when executed by the processing system, cause the processing system to perform operations. The operations may include identifying a first type of a vehicle to be operated by a driver, monitoring operational metrics of the vehicle while the vehicle is being operated by the driver during a journey, generating a first vehicle operation score for the journey, generating an aggregated vehicle operation score based at least on: the first vehicle operation score and a second vehicle operation score for a second type of a vehicle previously operated by the driver, wherein the first type is distinct from the second type, and executing at least one remedial action based on the aggregated vehicle operation score.

### BRIEF DESCRIPTION OF THE DRAWINGS

The teachings of the present disclosure can be readily understood by considering the following detailed description in conjunction with the accompanying drawings, in which:

FIG. 1 illustrates an example system related to the present disclosure;

FIG. 2 illustrates a flowchart of an example method for implementing a remedial action in response to an aggregated vehicle operation score; and

FIG. 3 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses devices, non-transitory (i.e., tangible or physical) computer-readable storage media, and methods for implementing a remedial action in response to an aggregated vehicle operation score. For instance, in one example, a processing system including at least one processor may implement a remedial action in response to an aggregated vehicle operation score.

Again, the behavior of an individual can be determined in many different contexts that can be beneficially utilized to assist the individual in performing a task, e.g., the operation of a vehicle (e.g., a car, a van, a truck, a bicycle, a scooter, a motorboat, a sailboat, a jetski, a drone, etc.) or to provide insights to a third party service provider who may currently be providing a service to the individual. For example, operation of a vehicle (broadly a mobile platform of any type) may be a daily occurrence for many individuals. The operational metrics of the vehicle are currently not effectively collected and/or utilized to provide benefits to the individuals. Operational metrics may comprise one or more of: a speed of the vehicle, an acceleration of the vehicle, a deceleration or braking of the vehicle, a lane keeping of the vehicle, a lane changing of the vehicle, a loading of the vehicle (e.g., the amount of passengers and/or cargos loaded onto the vehicle), an observance of traffic rules and regulations and the like. Non-operational metrics may comprise one or more of: a compliance to the maintenance schedule of the vehicle (e.g., performing scheduled maintenance tasks outlined by a manufacturer such as changing various fluids (e.g., engine oil, transmission fluid, brake fluid, etc.) and changing consumables (e.g., brake pads, windshield wipers, air filters, etc.), returning a rental vehicle on a previously agreed time, returning a rental vehicle on a previously agreed location, returning a rental vehicle without any damages, returning a rental vehicle without violating any specified constraints (e.g., not allowed to drive the vehicle off road or on salt covered flats like the salt plains of Utah), returning a rental vehicle in a clean state, operating a rental vehicle without violating any local traffic rules or laws, and the like.

It has been noted that the same driver might behave very differently depending on the mobility platform being used and/or rented (e.g., a truck, a van, a car, a motorcycle, a bicycle, a scooter, a motorboat, a sailboat, a drone, and the like), depending on the time of the day (e.g., early in the morning, late in the afternoon, early evening, during the late night, etc.), or depending on the occupancy level during the operation of the vehicle (e.g., no passenger, with adult passengers only, with children passengers only, with adult and children passengers, with co-workers during a carpool, with pets, and so on). For example, a driver who drives with his or her family (e.g., taking kids to school) might drive slower and more carefully than when driving alone on a weekend or when returning from a night party with friends. Furthermore, a driver might drive very differently based on the type of mobility platform such as: a rental truck, a family car, a rental sports car, a rental scooter, a rental bicycle, or a rental boat. Each platform type and different time of the day may create a different operator profile (e.g., a vehicle usage profile, or a driver profile) of the driver. In one embodiment, a driver may have a single operator profile having a plurality of stored performance metrics collected from a plurality of different types of vehicles operated by the driver. The operator profile may also store non-operational metrics and detected environmental conditions during each journey or trip taken by the operator. In one embodiment of the present disclosure, an aggregated vehicle operation score is generated from the plurality of stored performance metrics collected from the plurality of different types of vehicles operated by the driver.

It should be noted that different operator profiles represent different risks, preferences, goals, habits, as well as other aspects of the driver and vehicle usage patterns. For example, operator telematics-based scores (or driver telematics-based scores) are currently not sufficiently granular to differentiate between different mobility types, different types of use, different times of use, and more importantly such a score is not even generated to be used at all. To illustrate, most insurance plans base their pricing mainly on the driver's associated risk, e.g., the highest potential risk based on historical data (e.g., number of years of driving, driving history obtained from a department of motor vehicles, insurance claims made, etc.). However, for new customers no such data is available to companies such as insurance companies or car rental companies. Without pertinent data, young operators are often unfairly subjected to the highest insurance rates and car rental rates associated with the highest risks. In fact, some car rental companies may not even provide any services to such young vehicle operators, e.g., below the age of 25. Such broad unfavorable treatment of a large group of individuals is a disservice to the community and a loss of opportunity to the various service providers.

For example, there is currently no data source available that monitors multiple mobility platforms, manufacturers and/or rental/sharing services, and then integrates these different mobile device data sets into an aggregated operator score (also referred to as “aggregated vehicle operation score”). Currently, some insurance companies may offer driver monitoring/discount programs using their own monitoring devices. However, these monitoring devices are installed on a particular vehicle and does not have any integration capabilities, e.g., integrating operator performance metrics across multiple mobile platforms. For example, a physical telematics device, also known as a dongle, is installed or plugged into a driver's vehicle to monitor the driving habits of the driver, thereby allowing a rate to be determined that more accurately represents the driver's risk. This limited approach does not provide an accurate assessment of the risk for a number of reasons. First, such use of the dongle is limited to one particular mobile platform, e.g., a single car. Second, such use of the dongle often does not distinguish different users who may operate the same vehicle. Third, such use of the dongle is often time limited, e.g., for a specified time period such as three months, six months, etc. in which the dongle will be removed after the specified time period. Thus, this limited approach encourages best behavior only during the probationary period. Fourth, such use of the dongle does not provide any insights as to the same user who may operate other vehicles without any dongles or other monitoring devices.

In one embodiment of the present disclosure, the present method gathers operator data across multiple vehicle types and/or across different time periods to provide an operator profile that contains metrics/operator scores for each mobility platform (and also with the associated detected environmental conditions, e.g., start and end timestamps to denote the time of day when the journey or trip was taken and completed). More specifically, the operator profile may further comprise an overall or aggregated operator score that reflects an aggregation of the metrics/operator scores for a plurality of mobility platforms, e.g., an overall or aggregated operator score that reflects the operator's behavior in the operation of two or more of: a truck, a van, a car, a motorcycle, a bicycle, a scooter, a boat, a drone and the like. In one embodiment, the plurality of mobility platforms are owned by the operator, whereas in another embodiment, the plurality of mobility platforms are both partially owned by the operator and/or rented from other service providers, e.g., car rental companies, truck rental companies, scooter rental companies, and the like.

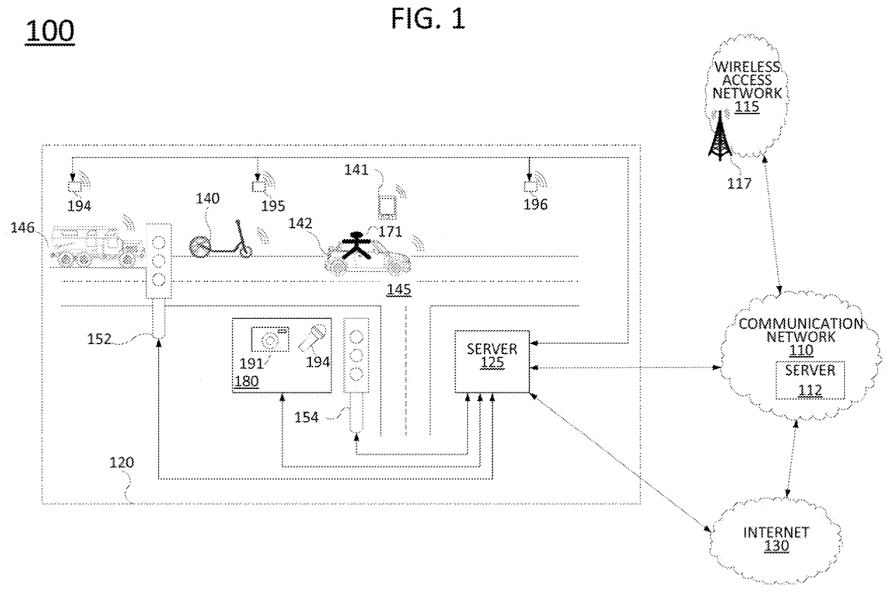

Thus, service providers such as insurance, rental, and vehicle sharing services can use the present unified operator profile to provide a more tailored pricing to consumers and/or build personal plans for each user according to the unified operator profile. It has been observed that the unified operator profile containing performance metrics across multiple mobile platforms offer a more accurate performance/risk assessment of an operator. In one embodiment, one or more remedial actions can be taken based on the unified operator profile containing the aggregated vehicle operation score, e.g., 1) interacting with a vehicle controller to implement one or more vehicle features and/or constraints, 2) presenting the operator with one or more recommendations, and/or 3) presenting the unified operator profile to a third party service provider to obtain a new service contract, e.g., a new rate, a new coverage, a new service, and the like. Furthermore, in one embodiment of the present disclosure the one or more aggregated scores can be further adjusted for situational factors like the time of day, the day of the week, the route taken by the vehicle, the number of passengers in the vehicle, and other personal preferences, etc. Such granularity of aggregated factors allows a more accurate assessment of the operator. Furthermore, in one embodiment, artificial intelligence/machine learning can be implemented to evaluate the unified operator profile for the purpose of implementing the appropriate remedial actions. For example, a pattern may be discovered by the artificial intelligence/machine learning algorithm that a certain remedial action is appropriate for a certain aggregated vehicle operation score. For example, if the aggregated vehicle operation score indicates a general disregard or carelessness as to lane changing or keeping within a designated lane, then the appropriate remedial action may comprise implementing at least one feature or at least one constraint on the vehicle, e.g., 1) limiting the maximum volume of the vehicle audio system to ensure the driver is able to hear other drivers on the road, 2) automatically turning on a lane changing signal for the driver when a lane change is detected to warn neighboring drivers, 3) directing the cameras within the vehicle (when available) to monitor driver attentiveness (e.g., detecting if the driver is sleepy or not focused on the road to provide an audio or tactile warning), 4) turning off the ringer of any mobile devices of the driver connected to the vehicle (e.g., turning off the ringer of a cell phone while the car is operating above a certain speed limit), 5) turning on the day time running headlights of the vehicle, 6) recommending the driver to engage the auto-pilot or driver steering-assist function (if available) of the vehicle, and so on. These and other aspects of the present disclosure are discussed in greater detail below in connection with the examples of FIGS. 1-3.

To aid in understanding the present disclosure, FIG. 1 illustrates an example system 100, related to the present disclosure. As shown in FIG. 1, the system 100 connects a mobile device 141 (belonging to a driver 171), server 112, server 125, wireless access points 194-196, sensor units (such as sensor unit 180, which may include a camera 191, a microphone 194, and so forth), vehicles 140, 142, and 146, and network-controllable physical resources (e.g., traffic lights 152 and 154) with one another and with various other devices via a core network, e.g., a communication network 110, a wireless access network 115 (e.g., a cellular network), and Internet 130. In the example of FIG. 1, wireless access points 194-196, traffic lights 152 and 154, and server 125 may be components of a transportation service provider network 120. The transportation service provider network 120 may comprise a Local Area Network (LAN), e.g., an Ethernet network, a wireless local area network (WLAN), e.g., an Institute for Electrical and Electronics Engineers (IEEE) 802.11 network (e.g., a Wi-Fi network), an IEEE 802.15, e.g., a Bluetooth network, a ZigBee network, and so forth, or a combination of interconnected devices using a plurality of such communication modalities and protocols. In one example, the transportation service provider network 120 may comprise a dedicated short range communication (DSRC) network. For example, a DSRC network may be operated by a governmental entity or a private entity managing a transportation region on behalf of a governmental entity. In general, DSRC networks enable wireless vehicle-to-vehicle (V2V) communications and vehicle-to-infrastructure (V2I) communications. The wireless access points 194-196 may comprise IEEE 802.11 (Wi-Fi) routers, IEEE 802.15 access points (e.g., “Bluetooth” access points, “ZigBee” access points, etc.), and so forth. In one example, the wireless access points 194-196 may be referred to as roadside units (RSUs).

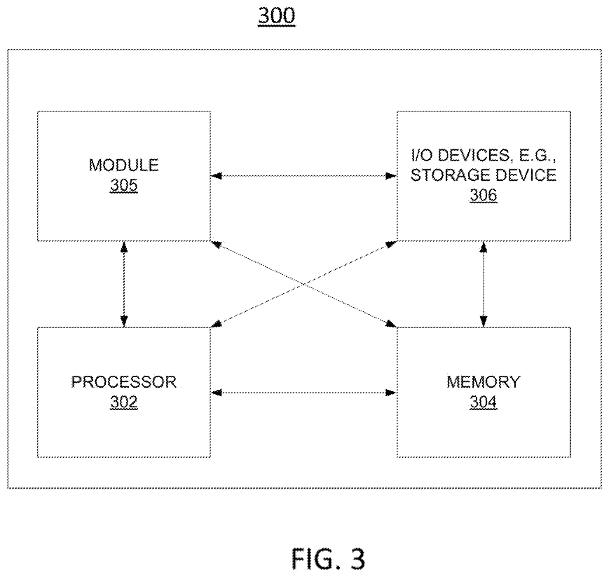

In one example, the mobile device (also referred to as a wireless user endpoint device) 141 and/or the server 125 may comprise a computing system, such as computing system 300 depicted in FIG. 3, and may be configured to provide one or more functions for monitoring, collecting, and/or providing vehicle operation metrics for the generation of an aggregated vehicle operation score to effect a remedial action, in accordance with the present disclosure. For example, the wireless user endpoint device 141 and/or the server 125 may be configured to perform one or more steps, functions, or operations in connection with the example method 200 described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the system 100 includes a communication network 110. In one example, communication network 110 may comprise a core network, a backbone network or transport network, such as an Internet Protocol (IP)/multi-protocol label switching (MPLS) network, where label switched routes (LSRs) can be assigned for routing Transmission Control Protocol (TCP)/IP packets, User Datagram Protocol (UDP)/IP packets, and other types of protocol data units (PDUs), and so forth. It should be noted that an IP network is broadly defined as a network that uses Internet Protocol to exchange data packets. However, it will be appreciated that the present disclosure is equally applicable to other types of data units and transport protocols, such as Frame Relay, and Asynchronous Transfer Mode (ATM). In one example, the communication network 110 uses a network function virtualization infrastructure (NFVI), e.g., host devices or servers that are available as host devices to host virtual machines comprising virtual network functions (VNFs). In other words, at least a portion of the communication network 110 may incorporate software-defined network (SDN) components.

As shown in FIG. 1, communication network 110 (e.g., a telecommunication network) may also include a server 112. In one example, the server 112 may comprise a computing system, such as computing system 300 depicted in FIG. 3, and may be configured to provide one or more functions for monitoring, collecting, and/or providing vehicle operation metrics for the generation of an aggregated vehicle operation score to effect a remedial action, in accordance with the present disclosure. For example, server 112 may be configured to perform one or more steps, functions, or operations in connection with the example method 200 described below. For instance, server 112 may collect, store, and provide vehicle operation metrics for the generation of an aggregated vehicle operation score to effect a remedial action which may be utilized in connection with the example method 200 described herein. For ease of illustration, various additional elements of communication network 110 are omitted from FIG. 1.

In one example, wireless access network 115 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 115 may comprise an access network in accordance with any “second generation” (2G), “third generation” (3G), “fourth generation” (4G), Long Term Evolution (LTE) or any other existing or yet to be developed future wireless/cellular network technology. While the present disclosure is not limited to any particular type of wireless access network, in the illustrative example, wireless access network 115 is shown as a UMTS terrestrial radio access network (UTRAN) subsystem. Thus, base station 117 may comprise a Node B or evolved Node B (eNodeB). As illustrated in FIG. 1, mobile device 141 may be in communication with base station 117, which provides connectivity between mobile device 141 and other endpoint devices within the system 100, various network-based devices, such as server 112, and so forth. In addition, in one example, vehicles 140 (e.g., a car), 142 (e.g., a scooter) and 146 (e.g., a truck) may also be in communication with base station 117, e.g., where these components may also be equipped for cellular communication. In one example, wireless access network 115 may be operated by the same or a different service provider that is operating communication network 110.

In one example, vehicles 140, 142 and 146 may each be equipped with an associated on-board unit (OBU) or a vehicle master controller (e.g., a computing device and/or processing system) for communicating with server 112, server 125, or both, either via the wireless access network 115 (e.g., via base station 117), via the transportation service provider network 120 (e.g., via wireless access points 194-196), or both. For example, the OBU may include a global positioning system (GPS) navigation unit that enables the driver to input a destination, and which determines the current location, calculates one or more routes to the destination, and assists the driver in navigating a selected route. In one example, the server 125 or server 112 may provide navigation assistance in addition to providing operations for monitoring, collecting, and/or providing vehicle operation metrics for the generation of an aggregated vehicle operation score to effect a remedial action, as described herein. In addition, in one example, one or more of the vehicles 140, 142 and 146 may comprise autonomous or semi-autonomous vehicles which may handle various vehicular operations, such as braking, accelerating, slowing for traffic lights, changing lanes, etc. For instance, vehicles 140, 142 and 146 may include LIDAR systems, GPS units, and so forth which may be configured to enable vehicles 140, 142 and 146 to travel to a destination with little to no human control. In other words, such systems provide some level of auto-pilot or driver steering-assist functions.

In an illustrative example, user 171 may be registered with server 125 or server 112 as a user who will be monitored for the collection of vehicle operation metrics for the generation of an aggregated vehicle operation score to effect a remedial action. For instance, user 171 may be a young driver who is in a probationary or assessment period. Alternatively, user 171 may be an elderly driver who is in an assessment period for the purpose of obtaining recertification of a driver license. In one embodiment, the probationary or assessment period can be set to a predefined time period, but may also be implemented on a continual basis. In another instance, user 171 may simply be a driver of any age who is in an assessment period, e.g., to obtain a lower rate for one or more services, e.g., a lower car insurance rate, a lower car rental rate, a lower home owner insurance rate, a lower mortgage rate, and the like. In another instance, user 171 may simply be a driver of any age who is being monitored for his or her vehicle operational metrics for implementing one or more remedial actions, e.g., activating one or more features of a vehicle or deactivating (or limiting) one or more features of a vehicle. In one example, user 171 provides specific consent (e.g., opted-in) to have communication network 110 monitor the user 171's vehicle operational metrics, and the communication network 110 may then register the user 171 as someone who has authorized other third party service providers (e.g., specifically selected by the user 171) to access user 171's vehicle operational metrics.

In one example, mobile device 141 may comprise any subscriber/customer endpoint devices configured for wireless communication such as a laptop computer, a Wi-Fi device, a Personal Digital Assistant (PDA), a mobile phone, a smartphone, an email device, a computing tablet, a messaging device, and the like. In one example, mobile device 141 may have both cellular and non-cellular access capabilities and may further have wired communication and networking capabilities. In one example, mobile device 141 may be associated with user 171. In one embodiment, mobile device 141 may be configured (e.g., having a dedicated software application such as an applet) to forward the user 171's vehicle operational metrics to server 125 and/or server 112 using cellular communications via base station 117 and wireless access network 115.

In one example, the server 125 may gather vehicle operational metrics of a plurality of drivers (e.g., users) from various sources. In one embodiment, certain contextual or environmental information may be obtained from server 112. For instance, server 112 may provide to server 125 position/location information of mobile device 141 (which is indicative of the position/location of user 171). In another example, server 112 may also provide vehicle identification information, e.g., a license plate of the vehicle operated by the user, an identification of a toll paying device (e.g., RFID tag and/or transponder) situated within the vehicle, an identification of an OBD situated within the vehicle, and the like. Such identifications will allow the server 125 to associate pertinent vehicle operational metrics to pertinent drivers. For example, if a vehicle is detected to have run a red street light, then such vehicle operational metrics can be associated to a registered vehicle if the vehicle identification is provided such as the vehicle's license plate numbers.

In various embodiments, vehicle operational metrics may include position, speed, acceleration, braking, lane changing, lane changing signal operations, length of cellular communications while operating the vehicle, and the like of vehicles 140, 142, and 146. It should be noted that vehicles 140, 142 and 146 may report such information to server 125 or server 112 via respective on-board units (OBUs). However, in one example, such information for vehicles 140, 142, and 146 may be obtained via sensors 180 in transportation service provider network 120, such as camera 191, microphone 194, overhead speed sensors or in-road speed sensors (not shown), and so forth. In one example, contextual or environmental information may also include navigation information for vehicles 140, 142, and 146, and/or user 171 (e.g., mobile device 141).

In one example, server 125 may alternatively or additionally control one or more traffic lights 152 and 154, e.g., to change to red, or to be maintained as red to stop traffic near the user 171, including the vehicle 142. For instance, traffic light 154 may be on one side of the roadway 145 and may be changed to red in an attempt to stop traffic including the vehicle 142. If the vehicle 142 obeys the red signal, then no vehicle operational metric for that event is stored. If the vehicle 142 does not obey the red signal, then the vehicle operational metric for that event associated with vehicle 142 is captured and stored. Alternatively, the vehicle 142 itself may have forward-facing cameras and such running of the red street light can also be detected and recorded by the vehicle's own OBD. In such scenario, vehicle operational metric for this event can be communicated to the user mobile device 141 and/or to server 125 or server 112 by the vehicle's own OBD. Again, such monitoring and reporting are performed only with the user's specific consent or the user's guardian's consent. For example, a parent of an underage or probationary driver may opt-in to such monitoring and reporting service.

It should also be noted that the system 100 has been simplified. In other words, the system 100 may be implemented in a different form than that illustrated in FIG. 1. For example, the system 100 may be expanded to include additional networks, and additional network elements (not shown) such as wireless transceivers and/or base stations, border elements, routers, switches, policy servers, security devices, gateways, a network operations center (NOC), a content distribution network (CDN) and the like, without altering the scope of the present disclosure. In addition, system 100 may be altered to omit various elements, substitute elements for devices that perform the same or similar functions and/or combine elements that are illustrated as separate devices.

As just one example, one or more operations described above with respect to server 112 may alternatively or additionally be performed by server 125, and vice versa. In addition, although individual servers 112 and 125 are illustrated in the example of FIG. 1, in other, further, and different examples, the same or similar functions may be distributed among multiple devices within the communication network 110 and/or transportation service provider network 120 that may collectively provide various services in connection with examples of the present disclosure for monitoring, collecting, and/or providing vehicle operation metrics for the generation of an aggregated vehicle operation score to effect a remedial action. Thus, these and other modifications are all contemplated within the scope of the present disclosure.

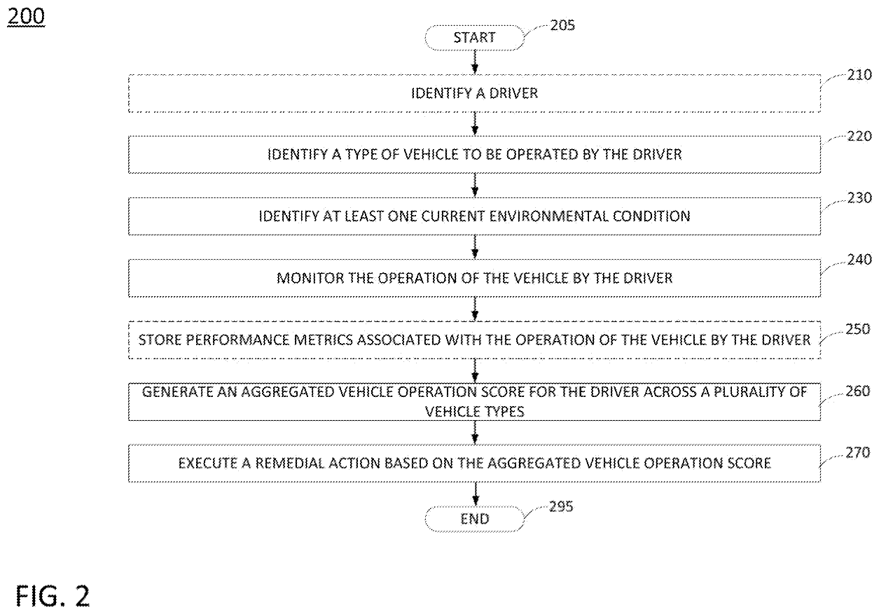

FIG. 2 illustrates a flowchart of an example method 200 for monitoring, collecting, and/or providing vehicle operation metrics for the generation of an aggregated vehicle operation score to effect a remedial action. In one example, steps, functions and/or operations of the method 200 may be performed by a device as illustrated in FIG. 1, e.g., by one of: mobile device 141, server 112 and/or server 125, or any one or more components thereof, such as a processing system. Alternatively, or in addition, the steps, functions and/or operations of the method 200 may be performed by a processing system collectively comprising a plurality of devices as illustrated in FIG. 1, such as server 125, server 112, mobile device 141, wireless access points 194-196, vehicles 140, 142 and 146, network-controllable physical resources (traffic lights 152 and 154), and so forth. In one example, the steps, functions, or operations of method 200 may be performed by a computing device or system 300, and/or a processing system 302 as described in connection with FIG. 3 below. For instance, the computing device 300 may represent at least a portion of a server, a mobile device, and so forth in accordance with the present disclosure. For illustrative purposes, the method 200 is described in greater detail below in connection with an example performed by a processing system, such as processing system 302. The method 200 begins in step 205 and proceeds to step 210.

At optional step 210, the processing system identifies a driver (broadly also referred to as an operator), connected with a vehicle (e.g., a truck, a van, a car, a motorcycle, a bicycle, a scooter, a motorboat, a sailboat, a drone, and the like) that is or will be operated by the driver. For instance, the vehicle may already be registered with the driver. Alternatively, if the vehicle is not registered with the driver, but the driver will be operating the vehicle, then the driver can be identified prior to or while the vehicle is being operated. For example, the identity of the driver can be determined from at least one of: 1) the driver pairing the driver's mobile user endpoint device 141 with the vehicle's OBD, thereby allowing the vehicle 142 and the mobile user endpoint device 141 to identify the current driver of the vehicle, 2) all occupants of the vehicle will provide their identities (e.g., their names and/or pictures of themselves) to the vehicle's OBD via the occupants' own mobile endpoint devices and then a camera in the vehicle can identify a specific occupant sitting in the driver seat, 3) the driver entering a user specific ID code to activate the vehicle's engine, and the like.

At step 220, the processing system identifies a type of the vehicle to be operated by the driver. For example, the vehicle can be one of: a truck, a van, a car, a motorcycle, a bicycle, a scooter, a motorboat, a sailboat, a drone, and the like. It should be noted that this list of illustrative vehicle types is only illustrative and should not be interpreted as a limitation of the present disclosure, i.e., any other vehicle types are contemplated by the present disclosure. In one embodiment, the ownership information of the vehicle is also noted, e.g., whether the vehicle is owned by the driver, whether the vehicle is rented by the driver, or whether the vehicle is loaned to the driver (e.g., from a friend or a relative of the driver). More specifically, the driving pattern of a driver may differ significantly based on the ownership information of the vehicle, e.g., a driver may drive particularly more careful when operating a vehicle belonging to a parent or a friend, whereas a driver may drive particularly more spirited when operating a rental vehicle belonging to a rental company.

In one alternate example, the vehicle can also be identified via communication with at least one sensor device deployed in an environment that is in communication with the processing system. For example, the vehicle (e.g., can be a “connected” vehicle having a subscription service with a network service provider) may transmit the vehicle's location (e.g., measured via an onboard GPS or the like), as well as vehicle identifying information (e.g., an identification number (ID) or serial number) to the processing system. The information may be transmitted via one or more modalities, e.g., via a cellular-network, via a dedicated short range communication (DSRC) network, and so forth. Identification of the vehicle via sensor device(s) may also include contextual information from cameras, microphones, wireless sensors (e.g., RFID, Bluetooth, Wi-Fi direct, etc.), overhead traffic sensors, in-road traffic sensors (e.g., pressure sensors, or the like), or other sensors for object detection and recognition (e.g., determining a moving car from video of a roadway via a machine learning model/object recognition model for a “car”). Identification may include not only the identification of the vehicle but also the vehicle's location, which may be inferred from known locations of the sensor(s), and or interpolated more accurately from detections from multiple sensor(s).

At step 230, the processing system identifies at least one contextual or environmental condition associated with the operation of the vehicle. For example, the identified at least one environmental condition comprises one or more of: a time of day when the vehicle was operated, the weather (e.g., sunny, raining, snowing, sleeting, windy and the like) when the vehicle was operated, the occupancy level when the vehicle was operated (e.g., the driver was alone, or the driver was transporting at least one other adult, at least one other child, at least one co-worker, at least one family member, etc.), or types of location traversed by the vehicle (e.g., a city street, a congested city street, a tunnel, a bridge, a city expressway, a suburban highway, a highway traversing a very sparsely populated area, etc.). More specifically, the driving pattern of a driver may differ significantly based on the least one environmental condition associated with the vehicle, e.g., a driver may drive particularly more careful when operating a vehicle carrying a child to school, whereas a driver may drive particularly more spirited when operating a vehicle carrying one or more co-workers in an attempt to arrive at a worksite in a timely manner.

At step 240, the processing system monitors the operation of the vehicle and collects operational metrics of the vehicles. In one embodiment, operational metrics may comprise one or more of: a speed of the vehicle, an acceleration of the vehicle, a deceleration or braking of the vehicle, a lane keeping of the vehicle, a lane changing of the vehicle, a loading of the vehicle (e.g., the amount of passengers and/or cargos loaded onto the vehicle), an observance of local traffic rules and regulations, usage of vehicle signals or lights (e.g., lane changing light signals, emergency light signals, day time driving light signals, fog light signals, or car horn audio signals), usage of the auto-pilot or driver-assist steering system, usage of hands free communication system (e.g., using the vehicle's microphone and speakers to interact with a user's smart phone for talking and/or texting) and the like. The above list of operational metrics is only illustrative and should not be interpreted as a limitation of the present disclosure.

Additionally, in one embodiment, non-operational metrics may also be monitored and collected. For example, non-operational metrics may comprise one or more of: a compliance to the maintenance schedule of the vehicle (e.g., performing scheduled maintenance tasks outlined by a manufacturer such as changing various fluids (e.g., engine oil, transmission fluid, brake fluid, etc.) and changing consumables (e.g., brake pads, windshield wipers, air filters, etc.), returning a rental vehicle on a previously agreed time, returning a rental vehicle on a previously agreed location, returning a rental vehicle without any damages, returning a rental vehicle without violating any specified constraints (e.g., not allowed to drive the vehicle off road or on salt covered flats like the salt plains of Utah), returning a rental vehicle in a clean state, operating a rental vehicle without violating any local traffic rules or laws, and the like. The above list of non-operational metrics is only illustrative and should not be interpreted as a limitation of the present disclosure.

More specifically, the driving pattern of a driver may be deduced from the collected operational metrics and/or non-operational metrics. For example, monitoring a single operational metric, e.g., the speed maintained by a driver over a plurality of journeys, may provide a rudimentary view as to the driver's driving capability. However, monitoring a plurality of operational metrics will provide a more accurate or comprehensive assessment of the driver. For example, a driver who maintains proper speed of the vehicle would initially appear to be a safe driver. However, if other operational metrics indicate that the same driver has poor skill in keeping the vehicle in the designated lane, or that the driver consistently fails to use the signaling lights when changing lanes, then the driver's initial positive assessment may be modified in a negative manner, e.g., lowering the scoring for the driver. In another example, a driver's scoring may be increased slightly or biased favorably if the non-operational metrics indicate a conscientious or diligent driver. For example, historical behavioral patterns may indicate (e.g., learned from the application of machine learning algorithms) that car renters who return their rental cars within the time period as indicated in their rental reservations are often low risk drivers. Once such pattern is determined, then the present disclosure may also use these identified non-operational metrics in the generation of the aggregated vehicle operation score as further discussed below.

Similarly, to further increase assessment accuracy, the identified at least one environmental condition of step 230 can be used to further refine the assessment of the driver. For example, the system may detect that a particular driver often travels approximately 5 miles above the posted speed limits for some journeys, but often travels approximately 5 miles below the posted speed limits for some other journeys. When the operational metric of speed is combined with the environmental condition of time or weather, it may reveal that the driver maintains approximately 5 miles above the posted speed limits during day time hours or during sunny conditions, whereas the driver maintains approximately 5 miles below the posted speed limits during night time hours or during poor weather conditions such as rainy or foggy conditions. Thus, it may be determined that such driver behavior shows driver prudence and not driver inconsistency. In another example, a driver who consistently executes cycles of rapid acceleration followed by rapid deceleration of the vehicle would initially appear to be an unsafe, nervous or inexperienced driver. However, when the operational metric of acceleration/deceleration is combined with the environmental condition of types of location of the journey, it may reveal that the driver is traversing a very congested city street where cycles of rapid acceleration/deceleration are perfectly normal under the circumstances.

At optional step 250, the processing system may store the operational metrics of the vehicle and/or the associated at least one environmental condition. Namely, the monitored operational metrics of the vehicle, the non-operational metrics, and/or the associated at least one environmental condition can be stored locally for later retrieval and application, e.g., stored on the vehicle itself or on the mobile device 141. Alternatively, the monitored operational metrics of the vehicle, the non-operational metrics, and/or the associated at least one environmental condition can be transmitted to the server 112 and/or server 125 for storage or processing. Furthermore, it should be noted that in one embodiment for each instance of a journey of each vehicle (e.g., at the conclusion of the journey), a separate vehicle operation score is generated and stored, e.g., in an operator profile in step 250.

At step 260, the processing system generates an aggregated vehicle operation score, e.g., over a plurality of different mobility platforms (e.g., over at least two different types of vehicles or at two different types of vehicle based on ownership (e.g., a driver's own car and a rental car not owned by the driver)). For example, using the operator profile, the aggregated vehicle operation score can be generated that accounts for at least two separate vehicle operation scores of differing types as discussed below.

To illustrate, a driver may operate a car on January 1 for two hours. At the end of the journey or trip (e.g., when the car is turned off), a vehicle operation score is generated for that journey for that vehicle type. The vehicle operation score (VOS) can be calculated using one or more operational metrics, one or more non-operational metrics, and/or one or more environmental conditions. For example, the vehicle operation score (VOS) can be calculated as follows:

VOS=X(one or more operational metrics)+Y(one or more non-operational metrics)+Z(one or more environmental conditions), where X,Y, and Z are weighing factors(e.g., from −1 to 1;−2 to 2;−3 to 3; and so on). EQU 1

In one embodiment, each operational and non-operational metric may have a range of values. For example only, for the operational metric of speed, the range of values may be (1-10) with 10 being the best and 1 being the worst. A driver who maintains within 5 miles of the posted speed limits for 90% of the journey may receive a value of 9, whereas a driver who maintains within 5 miles of the posted speed limits for 20% of the journey may receive a value of 2. In another example, satisfying any one of the above discussed non-operational metrics will accord the driver an additional value of 1, whereas a failure to satisfy any one of the above discussed non-operational metrics will accord the driver a subtraction of a value of 1 or simply no deduction of any kind (e.g., the non-operational metrics can be used to increase a driver's score but will not negatively impact the driver's score in one embodiment). For example, if a driver returns a rental car without any damage, then the driver receives an additional value of 1, whereas if the driver returns a rental car but was cited for violating a local rule or ordinance (e.g., getting a parking ticket), then the driver may receive a subtraction of the value of 1. In another example, if the environmental condition was a snowy day, then a value of 10 is given to the driver to offset any negative assessment given to the driver, whereas if the environmental condition was a sunny and dry day, then no additional value is given to the driver. It should be noted that the weighing factors X, Y, and Z can be selected based on implementation specific requirements. For example, an insurance company may weigh operational metrics and environmental conditions more significantly than non-operational metrics, whereas a car rental company may give equal weights to both operational metrics and non-operational metrics. Similarly, if the environmental condition indicates a congested roadway due to a high volume of traffic or an accident, then the weighing factor can be appropriately selected to counter a negative score associated with the driver's failure to maintain speed against the posted speed limits. Namely, a driver should not be assessed negatively for a condition that is not within the control of the driver. Thus, the values (e.g., 1 or greater for more importance and less than 1 for less importance) selected for these weighing factors X, Y, and Z can be tailored to specific applications and conditions.

Once a vehicle operation score (VOS) is generated for each journey of each vehicle, it can be stored for later retrieval. For example, a driver may have driven his own vehicle 142 five (5) times in the past week with the VOSs of (e.g., 15, 17, 18, 16, and 20). The processing system may generate an average VOS of 17.2 ((15+17+18+16+20)/5). It should be noted that the VOSs may need to be normalized, e.g., for the time taken for each journey. However, the driver may also have operated a rental scooter 140 and a rental truck 146 during the week with the respective VOSs of 30 and 25.

Return to step 260, the processing system generates an aggregated vehicle operation score (AVOS) for the driver across a plurality of vehicle types, e.g., across the car 142, the scooter 140 and/or the truck 146, where the aggregated vehicle operation score can be stored in an operator profile. For example, the aggregated vehicle operation score may be 20.14 (e.g., (15+17+18+16+20+30+25)/7). Again, it should be noted that AVOS may need to be normalized, e.g., for the time taken for each journey. Thus, in one embodiment the AVOS can be broadly expressed as:

AVOS=(A(vehicle type 1 VOS)+B(vehicle type 2 VOS)+ . . . N(vehicle type n VOS))/total number of vehicle type, where A, B and N are weighing factors. EQU 2

Again, it should be noted that the weighing factors A, B, and N can be selected based on implementation specific requirements. For example, an insurance company may weigh vehicle type 1 VOS (e.g., a car) and vehicle type 2 VOS (e.g., a truck) more significantly than vehicle type n VOS (e.g., a scooter), whereas a vehicle rental company may give equal weights to all three vehicle types. Thus, the values (e.g., 1 or greater for more importance and less than 1 for less importance) selected for these weighing factors X, Y, and Z can be tailored to specific applications and conditions.

It should be noted that the above values, ranges of values and equations 1 and 2 are only illustrative. Different values and metrics relationships can be selected to suit a particular application. In other words, different applications or use cases may weigh different operational/non-operational metrics and environmental conditions very differently. Thus, the above examples are only illustrative and should not be interpreted as a limitation of the present disclosure.

In one embodiment, artificial intelligence/machine learning algorithms can be deployed to select the most optimum operational, non-operational metrics and/or environmental conditions for a particular assessment application. For example, an insurance company may select a set of subscribers as examples of good drivers (e.g., low risk drivers) and a set of subscribers as poor drivers (e.g., high risk drivers). These data sets can be used as training data sets for artificial intelligence/machine learning algorithms. Once trained, the artificial intelligence/machine learning algorithms will be able to detect certain operational metrics, non-operational metrics and/or environmental conditions that will predict or distinguish a good driver versus a poor driver. More specifically, the operational metrics, non-operational metrics, and/or environmental conditions of a plurality of mobile platforms will be provided to the artificial intelligence/machine learning algorithms. Usage of such data sets from a plurality of mobile platforms will provide a more accurate operator assessment.

In one embodiment, wireless user endpoint device141 may also deploy one or more machine learning models (MLMs) associated with vehicle operational metrics, vehicle non-operational metrics, and at least one environmental condition. For instance, user endpoint device141 may obtain one or more MLMs from server(s) 112 or 125 that are stored in a machine learning model (MLM) database (DB). In one example, wireless user endpoint device141 may also retrain and update such MLM(s) based upon locally collected vehicle operational/non-operational metrics and detected environmental conditions.

In accordance with the present disclosure, providing one or more functions for monitoring, collecting, and/or providing vehicle operation metrics for the generation of an aggregated vehicle operation score to effect a remedial action may be in accordance with one or more machine learning algorithms (MLAs), e.g., one or more trained machine learning models (MLMs). For instance, a machine learning algorithm (MLA), or machine learning model (MLM) trained via a MLA may be for detecting and monitoring vehicle operation and/or non-operation metrics and environmental conditions associated with one or more types of mobile platforms. For instance, the MLA (or the trained MLM) may comprise a deep learning neural network, or deep neural network (DNN), a generative adversarial network (GAN), a decision tree algorithms/models, such as gradient boosted decision tree (GBDT) (e.g., XGBoost, or the like), a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on. Similarly, a regression-based model may be trained and used for prediction, such as linear regression, polynomial regression, ridge regression, lasso regression, etc. In one example, the MLM(s) may be trained at a network-based processing system (e.g., server(s) 125, server(s) 112, or the like). In step 270, the processing system executes a remedial action based on the aggregated vehicle operation score. For example, the processing system may generate an instruction or a control signal to implement one or more remedial actions. To illustrate, if the aggregated vehicle operation score falls below a first threshold value (e.g., a threshold value deemed to be the demarcation between potentially unsafe vehicle operation versus safe vehicle operation), then the processing system may send a control signal to an OBD or master controller of a vehicle to execute a constraint (e.g., deactivating or limiting a feature of the vehicle) or to execute a feature (e.g., activating an auto-pilot or assist steering function, activating route navigation with assistance from a heads-up display (HUD), and the like). For example, when the OBD of a vehicle detects that the driver (e.g., a young driver or an elderly driver) having a low aggregated vehicle operation score, a constraint can be implemented, e.g., the maximum speed of a vehicle can be lowered (e.g., the maximum vehicle speed of 120 mph can be limited to 75 mph), the vehicle may only be started by the driver during day time hours, the vehicle may only be started by the driver when there are no other occupants in the vehicle, and the like. In one embodiment, the processing system may provide a recommendation instead of implementing a constraint. For example, the processing system may recommend the taking of a safe driving course or performing a recertification driving test at a local department of motor vehicles center. If the driver's aggregated vehicle operation score subsequently rises above the first threshold value, then the constraints will be automatically removed.

In contrast, if the aggregated vehicle operation score raises above a second threshold value (e.g., a threshold value deemed to be the demarcation between potentially safe vehicle operation versus very safe vehicle operation), then the processing system may send a control signal to an OBD or master controller of a vehicle to allow access to a feature (e.g., allowing an auto-pilot or assist steering function to be activated). For example, in some circumstances, auto-pilot or assist steering systems are only executed or permitted if the driver complies with certain requirements such as keeping hands on the steering wheel at all times and maintaining vigilance while the vehicle is being managed by the auto-pilot or assist steering system. However, some drivers may misuse these auto-pilot or assist steering systems by failing to meet the requirements such as keeping their hands on the steering wheel and maintaining vigilance. Alternatively, the processing system may also forward the updated aggregated vehicle operation score to a third party service provider (e.g., an insurance company, a car rental company, and the like). If the updated aggregated vehicle operation score is sufficiently higher than a previous aggregated vehicle operation score, the third party service provider may offer a new contract with the driver (e.g., a lower premium rate, a lower rental rate, and the like).

Following step 270, the method 200 proceeds to step 295. At step 295, the method 200 ends.

It should be noted that the method 200 may be expanded to include additional steps, or may be modified to replace steps with different steps, to combine steps, to omit steps, to perform steps in a different order, and so forth. For instance, in one example the processing system may repeat one or more steps of the method 200 with respect to the same driver, but with respect to different mobile platforms, with respect to one or more different drivers, and so forth. In one example, the method 200 may be expanded to include detecting one or more other mobile endpoint devices of other occupants who are not the driver. In this embodiment, the driver's aggregated vehicle operation score can be shared with the other occupants who are not the driver via the other mobile endpoint devices of the other occupants. In this embodiment, the other occupants would be given an opportunity to assess the driver's capability in order to determine whether to share a ride with the driver. For example, the other occupants may have a car-pool arrangement with the driver. In another example, the driver may be the operator of a car ride sharing service arriving to pick up the other occupants. By sharing the driver's current aggregated vehicle operation score in advance, the other occupants are accorded the information to make a proper decision. In one embodiment, method 200 is implemented on the mobile device 141. In another embodiment, the method 200 is implemented on server 112 or server 125. Thus, these and other modifications are all contemplated within the scope of the present disclosure.

In addition, although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 3 depicts a high-level block diagram of a computing device or processing system specifically programmed to perform the functions described herein. For example, any one or more components or devices illustrated in FIG. 1 or described in connection with the method 200 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for providing one or more functions for monitoring, collecting, and/or providing vehicle operation metrics for the generation of an aggregated vehicle operation score to effect a remedial action, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for providing one or more functions for monitoring, collecting, and/or providing vehicle operation metrics for the generation of an aggregated vehicle operation score to effect a remedial action (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for providing one or more functions for monitoring, collecting, and/or providing vehicle operation metrics for the generation of an aggregated vehicle operation score to effect a remedial action (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
identifying, by a processing system including at least one processor, a first type of a vehicle to be operated by a driver;
monitoring, by the processing system, operational metrics of the vehicle while the vehicle is being operated by the driver during a journey;
generating, by the processing system, a first vehicle operation score for the journey;
generating, by the processing system, an aggregated vehicle operation score based at least on: the first vehicle operation score and a second vehicle operation score for a second type of a vehicle previously operated by the driver, wherein the first type is distinct from the second type; and
executing, by the processing system, at least one remedial action based on the aggregated vehicle operation score.

2. The method of claim 1, further comprising:
identifying, by the processing system, an identity of the driver.

3. The method of claim 2, wherein the identity of the driver is identified via a code entered by the driver.

4. The method of claim 1, wherein the identity of the driver is identified via a camera deployed within the first type of the vehicle.

5. The method of claim 1, wherein the identity of the driver is identified via a communication with a mobile device associated with the driver.

6. The method of claim 1, wherein the first type of the vehicle comprises at least one of:
a truck;
a van;
a car;
a motorcycle;
a bicycle;
a scooter;
a motorboat;
a sailboat; or
a drone.

7. The method of claim 6, wherein the second type of the vehicle comprises at least a different one of:
a truck;
a van;
a car;
a motorcycle;
a bicycle;
a scooter;
a motorboat;
a sailboat; or
a drone.

8. The method of claim 1, wherein the first type of the vehicle comprises a driver owned vehicle and wherein the second type of the vehicle comprises a rental vehicle.

9. The method of claim 1, further comprising:
identifying, by the processing system, at least one environment condition associated with the journey.

10. The method of claim 9, wherein the generating the aggregated vehicle operation score is further based on the at least one environment condition associated with the journey.

11. The method of claim 9, wherein the at least one environment condition comprises at least one of:
a time of day when the vehicle was operated;
a weather when the vehicle was operated;
an occupancy level when the vehicle was operated; or
a type of location traversed by the vehicle.

12. The method of claim 1, further comprising:
identifying, by the processing system, at least one non-operational metric.

13. The method of claim 12, wherein the generating the aggregated vehicle operation score is further based on the at least one non-operational metric.

14. The method of claim 12, wherein the at least one non-operational metric comprises at least one of:
a compliance to a maintenance schedule of the vehicle;
a returning of a rental vehicle on a previously agreed time;
a returning of a rental vehicle on a previously agreed location;
a returning of a rental vehicle without a damage to the rental vehicle;
a returning of a rental vehicle without violating a specified constraint;
a returning of a rental vehicle in a clean state; or
an operation of a rental vehicle without violating a local traffic rule.

15. The method of claim 1, wherein the operational metrics comprise at least two of:
a speed of the vehicle;
an acceleration of the vehicle;
a deceleration of the vehicle;
a lane keeping of the vehicle;
a lane changing of the vehicle;
a loading of the vehicle; or
an observance of at least one traffic rule by the driver.

16. The method of claim 1, wherein the at least one remedial action comprises:
activating a feature of the vehicle;
deactivating a feature of the vehicle;
limiting a feature of the vehicle; or
sending a recommendation to the driver.

17. The method of claim 1, wherein the at least one remedial action comprises:
sending, by the processing system, the aggregated vehicle operation score to a third party service provider; and
receiving, by the processing system, an offer from the third party service provider.

18. The method of claim 1, wherein the at least one remedial action comprises:
sending, by the processing system, the aggregated vehicle operation score to a mobile device of at least one occupant of the vehicle, wherein the at least one occupant is distinct from the driver.

19. A non-transitory computer-readable medium storing instructions which, when executed by a processing system including at least one processor, cause the processing system to perform operations, the operations comprising:
identifying a first type of a vehicle to be operated by a driver;
monitoring operational metrics of the vehicle while the vehicle is being operated by the driver during a journey;
generating a first vehicle operation score for the journey;
generating an aggregated vehicle operation score based at least on: the first vehicle operation score and a second vehicle operation score for a second type of a vehicle previously operated by the driver, wherein the first type is distinct from the second type; and
executing at least one remedial action based on the aggregated vehicle operation score.

20. An apparatus comprising:
a processing system including at least one processor; and
a computer-readable medium storing instructions which, when executed by the processing system, cause the processing system to perform operations, the operations comprising:
identifying a first type of a vehicle to be operated by a driver;
monitoring operational metrics of the vehicle while the vehicle is being operated by the driver during a journey;
generating a first vehicle operation score for the journey;
generating an aggregated vehicle operation score based at least on: the first vehicle operation score and a second vehicle operation score for a second type of a vehicle previously operated by the driver, wherein the first type is distinct from the second type; and
executing at least one remedial action based on the aggregated vehicle operation score.
